(19) United States
(12) Patent Application Publication
(10) Pub. No.: US 2008/0270939 A1
(43) Pub. Date: Oct. 30, 2008

(54) SYSTEM AND METHOD FOR RELATIONSHIP MANAGEMENT

(75) Inventor: Katrin Mueller, Weisbaden (DE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/742,121

(22) Filed: Apr. 30, 2007

(51) Int. Cl. G06F 3/048

(52) U.S. Cl. 715/811

(57) ABSTRACT

A network usage history associated with a user is obtained (202). The network usage history includes information relating to a first usage and a second usage of the network by the user. A graphical representation is formed that distinguishes the first usage and the second usage of the at least one network by the user and characterizes the first usage and the second usage (204). The graphical representation is presented to the user at the mobile station (206). Interactive navigation through the graphical representation presented to the user is facilitated in order to obtain information relating to a contact of the user and enable communication with the contact (208).

### FIELD OF THE INVENTION

The field of the invention relates to networks and, more specifically, to the relationships between different entities in these networks.

### BACKGROUND OF THE INVENTION

Networks allow users to communicate and otherwise interact with other users. For example, users may utilize networks to communicate with personal contacts such as friends or family members as well as non-personal contacts such as co-workers, clients, or other business-related individuals.

The pressures of modern life and the increased volume of personal and business contacts have made it increasingly difficult to understand and manage personal and non-personal relationships. For example, given the increased volume of personal and business contacts in today's society, it is often difficult for users to visualize, comprehend, and/or effectively manage their relationships. Additionally, efficient business and personal decisions are sometimes difficult to make, resulting in greater difficulty in achieving success in business and/or personal endeavors. Moreover, these problems may often create increased levels of stress and frustration for the individual user.

Some previous approaches have attempted to alleviate these problems and analyze relationships between different types of entities. For example, relationships between individuals have been analyzed based upon the particular communication mechanism being used (e.g., email). Unfortunately, in these previous approaches, only one type of relationship was analyzed and the user was not presented with a visual rendering of the relationship structure. In other previous approaches, a visual rendering was sometimes presented to the user; however, this rendering presented only a single relationship type and was never presented at a location convenient to the user (e.g., at the mobile station of the user).

In addition, these previous systems never took any type of automatic action after analyzing the relationships. For instance, once an analysis was complete, it was often left to the user to take some manual action based upon the results of the analysis. Additionally, although some previous systems allowed operating parameters of mobile devices to be changed, these parameter changes were not based upon the results of any relationship analysis but upon other considerations such as the geographic location of the user.

Consequently, users have been unable to effectively analyze their relationships at a convenient location (e.g., at their mobile device) using previous approaches. Moreover, previous approaches have been ineffective in allowing users to easily take advantage of the completed analysis to manage their relationships, take corrective actions when needed, and thereby balance their person and non-personal lives.

### BRIEF DESCRIPTION OF THE DRAWINGS

The above needs are at least partially met through provision of a system and method for relationship management described in the following description, particularly when studied in conjunction with the drawings, wherein:

FIG. 1 is block diagram of a system for relationship management according to various embodiments the present invention;

FIG. 2 is a flowchart of an approach for relationship management according to various embodiments of the present invention;

FIG. 3 is a flowchart of an approach for contact or device management according to various embodiments of the present invention;

FIG. 4 is a flowchart of another approach for contact or device management according to various embodiments of the present invention;

FIG. 5 is shows a graphical representation of network relationships that may be presented to a user according to various embodiments of the present invention; and

FIG. 6 is a block diagram of a device for providing relationship management functions to a user according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method are provided that facilitate relationship management and allow users to conveniently visualize and understand their relationships. In one example, the user is presented with a graphical representation of their relationships (e.g., personal and non-personal relationships) at a network element (e.g., their mobile station) thereby allowing the user to conveniently analyze the relationships, and, where appropriate, take action. In other examples, the configuration and/or operation of the mobile device of the user can be automatically adjusted and/or updated according to the results of a relationship analysis. Advantageously, these approaches can reduce user frustration associated with relationship management, enhance productivity associated with certain types of relationships (e.g., business relationship), and facilitate the achievement of a desirable relationship balance in the user's life.

In many of these embodiments, a network usage history associated with a user is obtained. The network usage history includes information relating to a first usage and a second usage of the network by the user. A graphical representation is formed that distinguishes the first usage and the second usage of one or more networks by the user and characterizes the first usage and the second usage. The graphical representation is presented to the user at the mobile station. Interactive navigation through the graphical representation presented to the user is facilitated by the system and allows a user to obtain information relating to a contact and/or enable communication with the contact.

The first and second usages may be any type of usage and can be set or defined by the user or by some other entity (e.g., the system provider). In one example, the first usage may be a personal-related usage and the second usage may be a non-personal-related usage. Other examples of usages are possible. It will be appreciated that any number of relationship types may be defined, analyzed, and displayed to the user in the graphical representation.

Different types of navigation and navigational movements may be provided through the graphical representation. For example, movement may be provided between a plurality of different levels of information associated with the graphical representation. In one specific example, a graphical indicator (e.g., icon) at a first level may be selected by the user (e.g., by clicking a computer mouse) in order to move to a second level.

In others of these embodiments, a set of rules is applied to the network usage history in order to determine a preferred contact list. For example, contacts may be ranked according to frequency of communication with the user and/or title or position of the contact. After being formed, the preferred contact list may be presented to the user at the mobile station, for instance, on a screen at the mobile station. The presentation of the contact list may facilitate communication with the contact (e.g., by the user selecting the contact on the screen).

The preferred contact list may also be analyzed and one or more mobile station actions may be determined based upon the analysis. These actions may take a number of forms. For instance, the actions may consist of presenting a reminder to the user to communicate with a contact on the preferred contact list or sending a message to a service provider. Other examples of actions are possible.

Additionally, a set of rules may be applied to the network usage history and, based upon a result of the application of these rules, one or more operating parameters of the device may be altered or adjusted. The operating parameters may include any number of parameters such as a call signal parameter, a volume of a call, an automatic decline setting, or a ring-tone type, to not but a few examples in this regard.

In addition to altering the operating parameters of mobiles stations, the operating parameters and/or operation of other network elements can also be altered or adjusted. For example, the configuration of devices at a network provider or the operation of network services can be adjusted.

Thus, approaches are provided that allow users to conveniently and effectively visualize and analyze their relationships at a mobile station. The present approaches are applicable to any relationship type and any number of relationship types. These approaches also allow for the automatic adjustment of the operating parameters and/or operation of network elements (e.g., mobile stations) as a result of the analysis. For example, the operating parameters of a mobile station can be adjusted based upon an analysis of the network usage history.

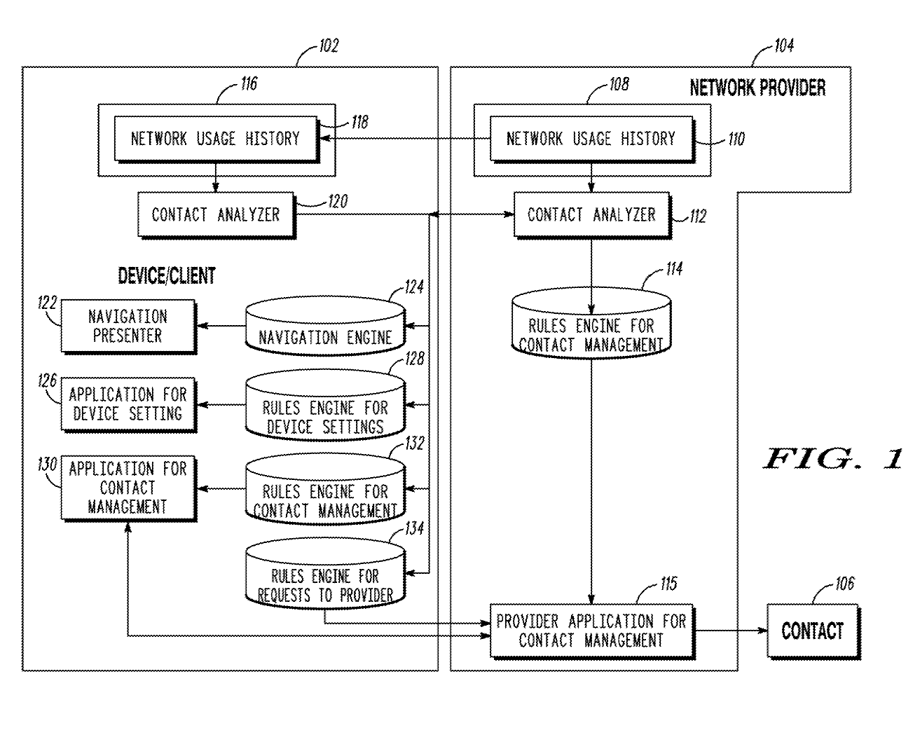

Referring now to FIG. 1, one example of a system for personal relationship management is described. The system includes a client device 102, a network provider 104, and a contact 106. The client device 102 and the contact 106 may be any type of communication device and, in one example, are mobile stations. The mobile stations may be cellular phones, pagers, personal digital assistants, personal computers, or any other type of mobile communication device.

In the present approaches, the relationships analyzed may be any type of relationship and the user or some other entity (e.g., the network provider) may select the particular relationships that are to be analyzed, characterized, and/or displayed. In one example, personal relationships (e.g., relationships between the user and friends) and non-personal relationships (e.g., relationships between the user and business associates) are selected by the user to be analyzed and displayed. However, other types of relationships (e.g., social, religious, or recreational-based relationships) can also be selected by the user (or some other entity) for analysis and/or presentation to the user. Moreover, any number of relationship types may be defined and analyzed using the present approaches. Regardless of the type or number, the relationships themselves represent any type of interaction between people controlled, initiated, or received by a user at the client device 102 and/or due to the user's use of the client device 102.

The client device 102 includes a memory 116 that stores a network usage history 118. The client device 102 also includes a contact analyzer 120, a navigation presenter 122, a navigation engine 124, an application for device setting 126, a rules engine for device settings 128, an application for contact management 130, a rules engine for contact management 132, and a rules engine for requests to provider 134.

The network usage history 118 includes information concerning the user's contacts. The network usage history 118 may be generated by the client device 102 and/or the network provider 104. The network usage history 118 may be stored as any type of data structure. For example, the network usage history 118 may be stored as a series of records with each record including the number and time of connections and appointments; the last connection or appointment; the type of communication; the initiator of the communication; a comparison of relationships; and a ratio between incoming and outgoing communications and appointments.

Besides the network usage history 118, other types of information may be stored in the memory 116 and utilized by the system. For example, information from a personal calendar may be stored in the memory 116 of the client device 102 and may also be used to perform various functions of the system.

The contact analyzer 120 is activated to analyze the network usage history 118 and process this information into a format that is convenient for use by the navigation engine 124, rules engine for device settings 128, rules engine for contact management 132, and rules engine for requests to provider 134 (collectively, the processing engines). For example, the network usage history 118 may be analyzed to determine the percentage of talk time taken by the contact 106 as well as by other contacts. The processed information is formatted into an appropriate data structure and is used by the processing engines to form other types of data structures (e.g., to form the contact list) or to provide other types of functions (e.g., navigation functions). The processing and formatting functions that are performed by the contact analyzer 120 allow the processing engines to concentrate on providing more specialized functions (e.g., navigation functions) and thereby enhance system efficiency.

The navigation engine 124 forms a graphical representation of the user's relationships. Specifically, the navigation engine 124 receives appropriate information from the contact analyzer 120 and forms data structures of the graphical representation to be displayed to a user. The navigation engine 124 forms these data structures so that they can be traversed and navigated by the user. Thereafter, the navigation presenter 122 receives the data structures representing the graphical representation and presents the graphical representation to the user, for example, on the display screen of the client device 102.

The rules engine for device settings application 128 applies a set of rules to information received from the contact analyzer 120 to alter operating parameters of the client device 102. For example, it may be determined if a contact has not communicated with the user for a predetermined time period. In another example, it is determined if the contact has not replied to a communication from the user within a predetermined period of time. The application for device setting 126 then sets the indicated operating parameters using, for example, drivers that set the appropriate operating parameters in the client device 102. For example, the operating parameters may include or relate to call signal parameters, volume of calls, automatic decline settings, or ring-tone types.

The rules engine for requests for contact management 132 receives information from the contact analyzer 120 and applies a set of rules to form a preferred contact list. The preferred contact list may be formed based upon the communication patterns with contacts, number of communications with contacts, goals of the system, or other types of factors. In one example, the preferred contact list is a ranking based upon the number of communications with contacts over a given period of time.

After being formed, the preferred contact list may be sent to application for contact management 130. The application for contact management 130 receives the contact list and facilitates direct interaction with the contact 106 (or other contacts) using the contact list. For instance, the application for contact management 130 may receive user input indicating the selection of a particular contact on the list and may then form messages (e.g., email messages) to be sent to the selected contact or establish a communication link with the contact. In other examples, the application for contact management 130 uses other information received from the rules engine for contact management 132 to take an action. For instance, the application for contact management 130 may receive a list of non-responsive contacts that have not responded to messages from the user. After receiving the list of non-responsive contacts, the application for contact management 130 may then automatically send communications (e.g., emails) to the contacts on the list.

The rules engine for contact management 132 also receives messages from the network provider 104. For example, the rules engine for contact management 132 may receive reminder messages to the user from the network provider 104 to respond to a message from the contact 106.

The rules engine for requests to provider 134 receives information from the contact analyzer 120 and applies a set of rules to this information to determine if a message should be sent to the service provider 104. For example, the rules engine for requests to provider 134 may determine when the service provider 104 should be sent a message to communicate with the contact 106.

The rules used by any of the processing engines 128, 132, or 134 may be static or dynamic and be stored in any convenient data structure or according to any selected and suitable computer program. The rules at the client device 102 may be pre-installed, defined by the user (e.g., by using a graphical user interface at the client device 102), or obtained from the network provider 104. The rules can be stored at the client device 102 and/or at the network provider 104. Additionally, the rules may be synchronized so that they are the same at different devices.

The network provider 104 includes a memory 108 and the memory includes a network usage history 110. The network provider 104 also includes a contact analyzer 112, a rules engine for contact management 114, and a provider application for contact management 115. The network provider 104 may also include or support other types of functions and/or services.

At the network provider 104, the network usage history 110 includes information concerning the user's contacts. As with the network usage history 118 (at the client device 102), the network usage history 110 may be stored as a series of records with each record including the number and time of connections and appointments; the last connection or appointment; the type of communication; the initiator of the communication; a comparison of relationships; and a ratio between incoming and outgoing communications and appointments. The network usage histories 110 and 118 may be identical and may be updated simultaneously. However, in other examples, one of the contact histories may be the master history and the other updated from this master copy.

The contact analyzer 112 is activated to analyze and deliver formatted input information taken from the network usage history 110 (e.g., percent of total talk time to a particular contact) to the rules engine for contact management 114. This information is formatted into an appropriate data structure and is used by the rules engine for contact management 114 to form other types of data structures (e.g., a contact list). The processing and formatting that is performed by the contact analyzer 112 allows the rules engine for contact management 114 to concentrate on providing more specialized functions and thereby operate more efficiently.

At the service provider 104, the rules engine for contact management 114 receives information from the contact analyzer 112 and applies a set of rules to determine whether to communicate with the contact 106 or with the client device 102. For example, the network provider 104 may send a reminder message to the client device 102 to respond to the contact 106 if the client device 102 has not responded to a message from the contact 106 after a predetermined length of time.

The provider application for contact management 115 receives instructions from the rules engine for contact management 114 and sends messages to the client device 102 and the contact 106. The provider application for contact management 115 also receives messages from the client device 102 and the contact 106. After receiving these messages, the provider application for contact management 115 processes the messages and performs any required processing.

In one example of the operation of the system of FIG. 1, the network usage history 118 associated with a user is obtained by the client device 102. The network usage history 118 is obtained from the network provider 104 and stored in the memory 116. The network usage history 118 includes information relating to a first usage (e.g., personal usage) and a second usage (e.g., non-personal usage) of the network by the user. As mentioned, any number of usages may be defined, analyzed, and presented to the user.

The contact analyzer 120 outputs information relating to the nature of the contacts to the navigation engine 124. A graphical representation is formed by the navigation engine that distinguishes the first usage and the second usage by the user. For example, different usage types may be placed at distinct locations of a display. The first usage and second usage are also characterized in the graphical representation. For example, time, duration, and frequency information may also be provided. The graphical representation is presented to the user at the mobile station by the navigation presenter 122. Interactive navigation through the graphical representation presented to the user is facilitated by the navigation presenter 122 in order to obtain information relating to a contact of the user and enable communication with the contact.

A determination of whether operating parameters of the client device 102 may be made by the rules engine for device setting 128. The application for device setting 126 may then change the appropriate operating parameters.

A preferred contact list may be formed by the rules engine for contact management 132. The contact list may be forwarded to the application for contact management 130, which displays it to the user.

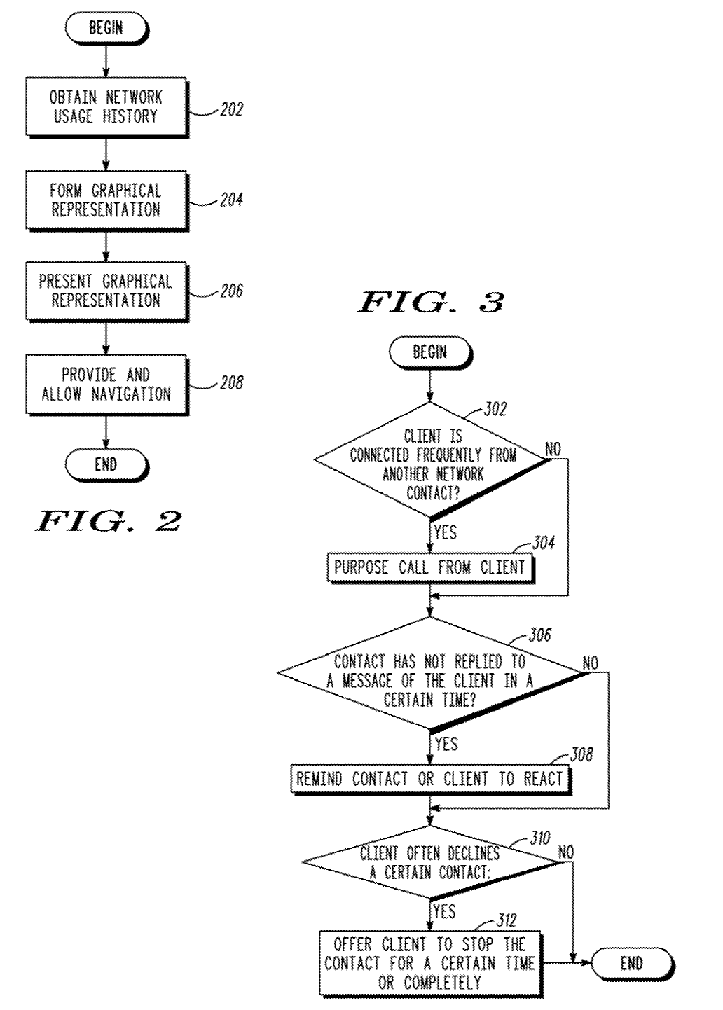

Referring now to FIG. 2, one example of an approach for relationship management is described. At step 202, the network usage history is obtained at a mobile device of a user. The network usage history may be in the form of any type of data structure. The network usage history may be obtained, for example, at the mobile device and formed from data received at that mobile station. In another example, the network usage history may be received from an outside source such as a network provider.

At step 204, a graphical representation is formed of the network usage history. The representation may be in any form, but in one preferred example, is in the form of a multi-level diagram or graph. In this step, the data obtained is formatted into the corresponding representation that can be displayed to a user. The graphical representation is formed so as to distinguish between relationship types (e.g., personal and non-personal relationships) and to characterize these relationships (e.g., present timing, duration, and frequency information associated with the relationships).

At step 206, the graphical representation of the network usage history is presented to the user. At step 208, the system provides for and allows navigation through the graphical representation. For instance, the user can enter input (e.g., click and select a portion of the graphical representation using a computer mouse or cursor control implement) and thereby navigate through the graphical representation.

Referring now to FIG. 3, an example of one approach for contact or device management is described. In one example, this approach is performed at a mobile station (e.g., the client device 102). At step 302, it is determined if a client is connected frequently with a particular contact. If the answer is affirmative, execution continues at step 304. On the other hand, if the answer at step 302 is negative, execution continues at step 306.

At step 304, a message is presented to the client proposing that the user communicate with the contact. For example, a text message may be flashed on a screen of the mobile station asking the user to communicate with the contact. In another example, an audio message may be presented to the user at the mobile station.

At step 306, it is determined if a contact has not replied to a message of the user within a given time period. For example, it may be determined if a contact has not replied to a message from the user at the mobile station within a day. If the answer is affirmative, execution continues at step 308 and if the answer is negative, execution continues at step 310.

At step 308, the user and/or the contact are reminded to react. For example, the user may be sent a message to communicate with the contact that is presented on a screen of the user. In another example, an audio message may be presented to the user at the mobile station to react.

At step 310, it is determined if the user at the mobile station often declines communications with a particular contact. For instance, it may be determined whether the user at the mobile station has declined to respond to communications with a contact more than three times in a week. If the answer is affirmative, then execution continues at step 312 and, if the answer is negative, execution ends.

At step 312, an offer is made to the user to stop communication with the contact for a period of time or completely. For example, a message may be sent to the user at the mobile station that states that communication is being stopped either completely or for some predetermined period of time. The user may enter appropriate instructions, for example, via a graphical user interface at their mobile station.

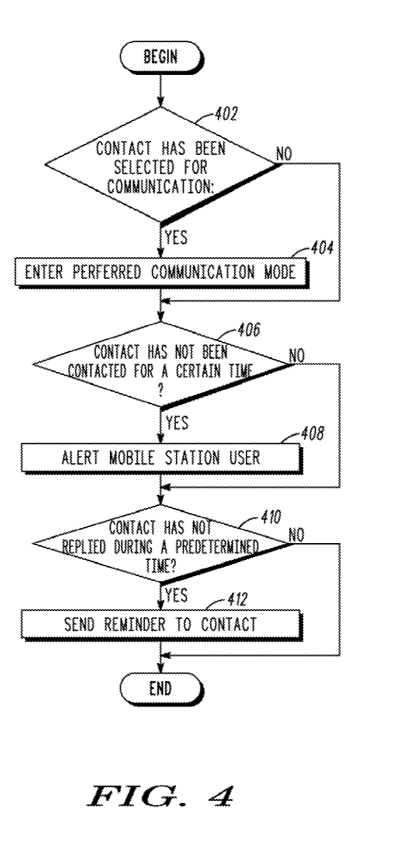

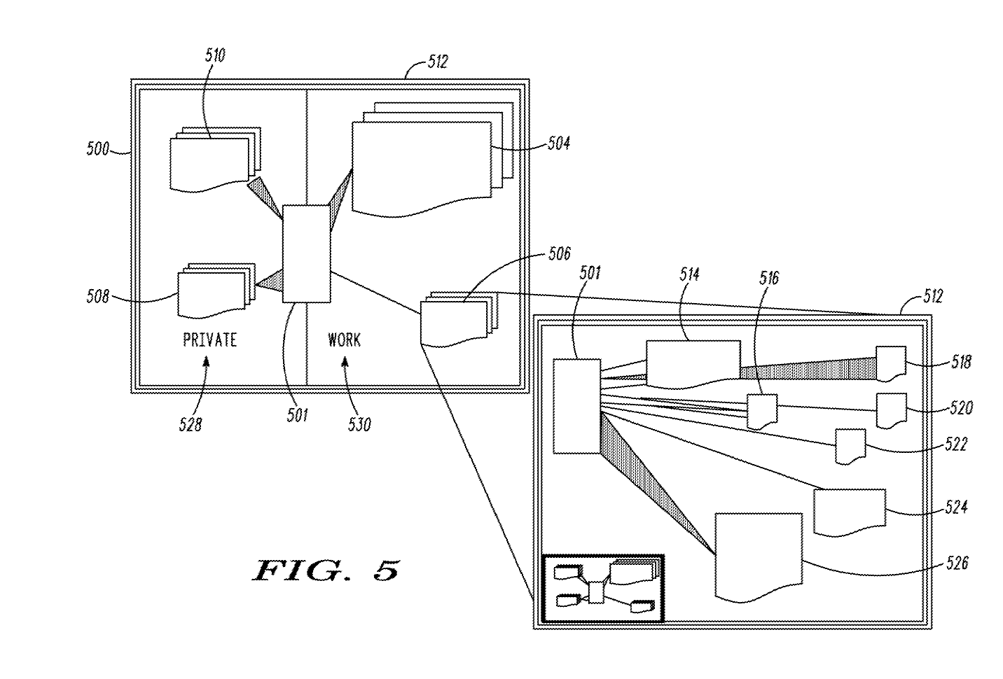

Referring now to FIG. 4, an example of an approach for contact or device management (e.g., as used in the client device 102) is described. At step 402, it is determined if a contact has been selected for communication. If the answer is affirmative, then execution continues at step 404 and, if the answer is negative, execution continues at step 406.

At step 404, a preferred communication mode is entered. The entering may include automatically switching the device into a preferred mode of operation. In one example, the mobile station may enter into a preferred mode such as text-message only mode of operation.

At step 406, it is determined if the contact has not been communicated with within a predetermined time period. If the answer is affirmative, then execution continues at step 408 and if the answer is negative, execution continues at step 410.

At step 408, the mobile station user is alerted to communicate with the contact. For example, a message may be flashed upon a screen on the mobile station. In this example, the message may be a reminder that communication has not been conducted with the contact for a predetermined time period.

At step 410, it is determined if the contact has not replied to a communication from the user within a predetermined period of time. If the answer is affirmative, then execution continues at step 412. On the other hand, if the answer is negative, execution ends.

At step 412, a reminder message is sent to the contact that asks the contact to communicate with the user. The reminder message may be in any form and may be communicated using any type of transmission medium. In one example, the reminder is in the form of an email.

Referring now to FIG. 5, one example of a screen showing a graphical representation of network usage being presented to a user is described. A representation of network usage 500 includes a private portion 528 and a work portion 530 representing private and work entities 504, 506, 508, and 510 of a user 501. Each of the entities 504, 506, 508, and 510 may represent an individual contact, groups of contacts (shown as a single entity), or another entity (e.g., a network).

A user can navigate through the representation of network usage 500 and reach other levels of the representation. For example, when the entity 506 is selected (e.g., by a computer mouse), the screen 512 is presented to the user to show that the entity 506 represents contacts 518, 520, 522, 524, and 526.

Information that characterizes the relationship may also be presented in the graphic representation. For example, the thickness or length of connecting lines in the graphic representation may represent communication frequency information. In other examples, timing and duration of communication information with contacts may also be presented.

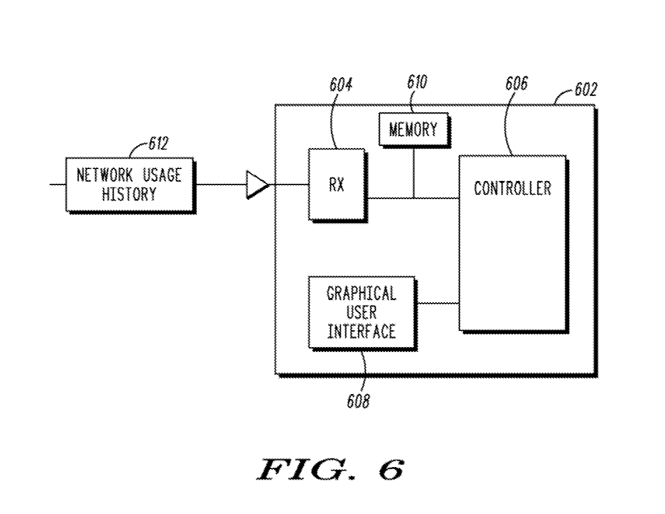

Referring now to FIG. 6, one example of a device 602 (e.g., a mobile station) for providing relationship management functions to a user is described. The device 602 includes a receiver 604, a memory 610, a controller 606, and a graphical user interface 608. In this example, a network usage history 612 is received at the input of the receiver 604. In other approaches, the network usage history 612 is formed at the device 602.

The receiver 604 is configured and arranged to obtain the network usage history 612 associated with a user. The usage history 612 includes information relating to a first usage and a second usage of at least one network by the user.

The controller 606 is configured and arranged to form a graphical representation that distinguishes between the first usage and the second usage and to present the graphical representation to the user on the graphical user interface 608. Characterization information (e.g., timing, duration, and frequency information) may also be included in the graphical representation. The controller 606 is further configured and arranged to receive user interactions from the graphical user interface 608 and navigate through the graphical representation according to the user interactions at the graphical user interface 608.

The user may define the different types of usages. For example, the first usage may be a personal-related usage and the second usage may be a non-personal-related usage. These usages may be preprogrammed into the device 602 or may be input by the user by using the graphical user interface 608. Although two usages are defined in this example, it will be understood that any number of usages may be distinguished, analyzed, and presented to the user.

The controller 606 is further programmed to apply a set of rules to the first usage and to the second usage and, based upon a result of the application of the rules, to alter one or more operating parameters of the device. The operating parameters may be call signal parameters, volumes of a call, automatic decline settings, or ring-tone types. Other examples of operating parameters are possible.

The controller 606 may be further programmed to determine a preferred contact list from the network usage history and to present the preferred contact list to the user at the graphical user interface 608. In addition, the controller 606 may be programmed to perform an analysis of the preferred contact list and to determine an action to take based upon the analysis.

Thus, approaches are provided that allow users to effectively and conveniently visualize and analyze their relationships (e.g., personal and non-personal relationships) at a mobile station or some other network element. These approaches also provide that actions can be automatically taken as a result of analyzing a user's usage history. For example, the operating parameters of a mobile station can be automatically adjusted according to an analysis of the usage history of the mobile station.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of operating a mobile station comprising:
obtaining a network usage history associated with a user, the network usage history comprising information relating to a first usage and a second usage of at least one network by the user;
forming a graphical representation that distinguishes the first usage and the second usage of the at least one network by the user and characterizes the first usage and the second usage;
presenting the graphical representation to the user at the mobile station; and
facilitating interactive navigation through the graphical representation presented to the user in order to obtain information relating to a contact of the user and enable communication with the contact.

2. The method of claim 1 wherein the first usage comprises a personal-related usage and the second usage comprises a non-personal-related usage.

3. The method of claim 1 wherein facilitating interactive navigation comprises facilitating movement between a plurality of different levels of information associated with the graphical representation.

4. The method of claim 3 wherein facilitating the movement between a plurality of different levels of information comprises facilitating the selection of a graphical indicator at a first level in order to move to a second level.

5. The method of claim 1 further applying a set of rules to the network usage history to determine a preferred contact list.

6. The method of claim 5 further comprising presenting the preferred contact list to the user at the mobile station.

7. A method of operating a mobile station comprising:
obtaining a network usage history associated with a user, the network usage history comprising information relating to a plurality of usages of at least one network by the user;
applying a set of rules to the plurality of usages of the at least one network by the user to provide corresponding results

8. The method of claim 7 further comprising, based upon the corresponding results, altering at least one operating parameter of a network element.

9. The method of claim 8 wherein the network element is selected from a group comprising: a mobile station and a network service.

10. The method of claim 7 further comprising determining a preferred contact list from the network usage history.

11. The method of claim 9 further comprising analyzing the preferred contact list to determine at least one mobile station action.

12. The method of claim 10 wherein the mobile station action is selected from a group comprising: presenting a reminder to the user to communicate with a contact on the preferred contact list; and sending a message to a service provider.

13. The method of claim 7 further comprising:
forming a graphical representation that distinguishes the plurality of usages of the at least one network by the user;
presenting the graphical representation to the user at the mobile station; and
facilitating interactive navigation through the graphical representation presented to the user in order to obtain information relating to a contact of the user.

14. A device comprising:
a receiver configured and arranged to obtain a network usage history associated with a user, the usage history comprising information relating to a first usage and a second usage of at least one network by the user;
a graphical user interface; and
a controller coupled to the receiver and the graphical user interface, the controller being configured and arranged to form a graphical representation that distinguishes between the first usage and the second usage and to present the graphical representation to the user on the graphical user interface, the controller further configured and arranged to receive user interactions from the graphical user interface and navigate through the graphical representation according to the user interactions.

15. The device of claim 14 wherein the first usage comprises a personal-related usage and the second usage comprises a non-personal-related usage

16. The device of claim 14 wherein the controller is further programmed to apply a set of rules to the first usage and the second usage and based upon a result of the application of the rules, to alter at least one operating parameter of the device.

17. The device of claim 16 wherein the at least one operating parameter is selected from a group comprising: a call signal parameter; a volume of a call; an automatic decline setting; and a ring-tone type.

18. The device of claim 14 wherein the controller is further programmed to determine a preferred contact list from the network usage history.

19. The device of claim 18 wherein the controller is further programmed to present the preferred contact list to the user at the graphical user interface.

20. The device of claim 19 wherein the controller is further programmed to perform an analysis of the preferred contact list in order to determine at least device action based upon the analysis.
